(19) United States
(12) Patent Application Publication
(10) Pub. No.: US 2026/0064355 A1
(43) Pub. Date: Mar. 5, 2026

(54) METHODS AND SYSTEMS FOR AUDIO DISTRIBUTION

(71) Applicant: JUKE AUDIO INC., Manhattan Beach, CA (US)

(72) Inventors: John Bradford FORTH, Rio Grande, PR (US); Bradford Colton FORTH, Manhattan Beach, CA (US); Jerry WOODS, Pittsburgh, PA (US); Yutong GU, Los Angeles, CA (US)

(21) Appl. No.: 19/319,628

(22) Filed: Sep. 4, 2025

Related U.S. Application Data
(60) Provisional application No. 63/690,736, filed on Sep. 4, 2024.

(51) Int. Cl. G06F 3/16

(52) U.S. Cl. CPC G06F 3/162; G06F 3/167

(57) ABSTRACT

According to an aspect of an embodiment, a method may include receiving, at an intermediary device, audio signals from an audio source via an input interface of a set of input interfaces, the set of input interfaces including at least one digital input interface and at least one analog input interface. In some embodiments, audio data may be generated based at least on the audio signals. The audio data may be transmitted to one or more downstream devices.

### CROSS-REFERENCE TO RELATED APPLICATIONS

This patent application claims priority to U.S. Provisional Application No. 63/690,736 filed Sep. 4, 2024, which is incorporated herein by reference in its entirety.

### FIELD

The embodiments discussed in the present disclosure are related to audio extraction and distribution system.

### BACKGROUND

Home entertainment systems have evolved to incorporate a wide variety of audio and video sources, including televisions, streaming devices, gaming consoles, and legacy analog equipment such as turntables and CD players. In many modern households, users desire the ability to extract, distribute, and manage audio signals from these diverse sources in a flexible and seamless manner. Traditionally, audio distribution within the home has relied on direct wired connections between source devices and output components such as soundbars, amplifiers, and speakers. While such configurations may provide adequate performance for single-room setups, they often lack the versatility and scalability needed to support multi-room audio playback, integration of legacy devices, or dynamic switching between different audio sources.

With the increasing prevalence of smart televisions and networked audio systems, there is a growing demand for solutions that can facilitate synchronized audio playback across multiple rooms or zones. Existing systems may require complex wiring, manual reconfiguration, or the use of multiple intermediary devices to achieve even basic multi-room functionality. Furthermore, many current solutions do not readily accommodate analog audio sources, which may require additional equipment for digital encoding and network integration. As a result, users may experience limitations in audio quality, synchronization, and ease of use when attempting to create a unified home audio environment.

There is therefore a need for devices and systems that can extract audio from a range of source devices, including both digital and analog sources, and distribute the audio to one or more output devices across a home network. Such systems may benefit from supporting both wired and wireless communication protocols, enabling integration with existing home network infrastructure and providing users with greater flexibility in configuring their entertainment systems. Additionally, it may be desirable for such devices to offer real-time digital encoding of analog inputs, user-friendly interfaces for managing audio routing and playback, and compatibility with both legacy and modern audio equipment.

The subject matter claimed herein is not limited to embodiments that solve any disadvantages or that operate only in environments such as those described above. Rather, this background is only provided to illustrate one example technology area where some embodiments described herein may be practiced.

### SUMMARY

According to an aspect of an embodiment, a method may include receiving, at an intermediary device, audio signals from an audio source via an input interface of a set of input interfaces, the set of input interfaces including at least one digital input interface may include and at least one analog input interface. In some embodiments, audio data may be generated based at least on the audio signals. The audio data may be transmitted to one or more downstream devices.

The object and advantages of the embodiments will be realized and achieved at least by the elements, features, and combinations particularly pointed out in the claims. It is to be understood that both the foregoing general description and the following detailed description are exemplary and explanatory and are not restrictive of the invention, as claimed.

### BRIEF DESCRIPTION OF THE DRAWINGS

Example embodiments will be described and explained with additional specificity and detail through the use of the accompanying drawings in which:

FIG. 1 is a block diagram illustrating an environment in which an intermediary device may be implemented;

FIG. 2 is a block diagram illustrating the architecture 200 for capturing, processing, and transmitting audio data;

FIG. 3 illustrates a flow chart of an example method distributing audio inputs;

FIG. 4 illustrates a table illustrating examples of data flow between devices;

FIG. 5 illustrates a block diagram of an example computing system that may be used with the multi-zone audio amplifier; and all in accordance with one or more embodiments of the present disclosure.

### DESCRIPTION OF EMBODIMENTS

One or more embodiments of the present disclosure may relate to an audio extraction and distribution system, that may distribute audio signals to multiple amplifiers or audio output devices. In some embodiments, an intermediary device may be configured to function as an intermediary between various audio sources (e.g., televisions) and output devices (e.g., soundbars, powered speakers, multi-room amplifier systems, etc.). The intermediary device may be configured to extract audio from the output stream of the audio sources and to transmit the audio in real-time to one or more audio output devices.

In some embodiments, the intermediary device may include one or more digital input interfaces configured to receive audio signals encoded in a digital format. Additionally or alternatively, the intermediary device may include analog input interfaces for receiving analog audio signals. In these and other embodiments, the multiple types of input interfaces may permit the intermediary device to receive input from various types of devices. In some embodiments, the intermediary device may process the input audio signals to generate processed audio data.

In some embodiments, the processed audio data may be communicated, via a network, to one or more amplifiers. The one or more amplifiers may be parts of a multi-zone amplifier system, in which the one or more amplifiers are placed in various locations, or one or more multi-zone amplifiers provide audio to one or more zones. In some embodiments, the intermediary device may transmit the audio data to the one or more amplifiers such that the amplifiers may process the audio data (e.g., output the audio via output devices such as speakers) in a substantially parallel manner with minimized latency and improved synchronization.

Additionally or alternatively, the intermediary device may deliver the audio data to one or more local devices, such as a sound bar. The local devices may include downstream devices that are physically connected to the intermediary device.

One or more embodiments of the present disclosure may help improve flexibility of entertainment systems and integration of various devices in the entertainment systems. For example, existing home entertainment systems are often implemented based on complex wiring, manual reconfigurations, and the use of multiple intermediary devices suitable for different input devices. For example, existing intermediary devices do not readily accommodate analog audio sources, which may require additional equipment for digital encoding and network integration.

For example, analog devices, such as turntables, cassette players, or legacy audio equipment, require digital encoding to be transmitted or utilized within modern audio systems. The lack of seamless integration for these analog sources limits the flexibility and usability of current audio systems. While amplifiers exist that include analog audio inputs, it is challenging to connect analog devices to them if the device and the amplifier are in different locations and a physical connection is difficult or impossible. In some instances, the additional equipment may cause limitations in audio quality, synchronization, and ease of use.

Another existing approach may include the use of interfaces designed for audio and video communication. For example, the HDMI (High-Definition Multimedia Interface) standard was introduced to simplify the connection between audio-visual devices by allowing both audio and video to be transmitted over a single cable. The introduction of HDMI improved the quality and ease of connecting devices. However, the HDMI also created new challenges for integrating audio systems, particularly in instances in which the audio needs to be distributed across multiple rooms or devices.

To address the need for improved audio routing, the HDMI Audio Return Channel (ARC) and its enhanced version, eARC (Enhanced Audio Return Channel), were developed. These technologies enable smart devices to send audio upstream to external audio devices, such as soundbars or AV receivers, using the same type of HDMI cable that delivers video to the TV. ARC and eARC may permit simplified connections and the elimination of additional cables. However, ARC and eARC do not inherently support the transmission of audio to other locations or devices within the home.

The challenge of distributing audio from a central unit to multiple rooms is further compounded by the need for solutions that can maintain audio synchronization and quality across various locations. Typical audio-visual receivers (AVRs) and sound systems are often designed to handle audio from external sources like Blu-ray players or gaming consoles, but they are not typically equipped to manage audio that originates directly from smart devices, especially in a multi-room context.

One or more embodiments of the present disclosure may disclose an intermediary device configured to extract audio data directly from the output stream and to transmit the audio data to one or more multi-room amplifier systems. The intermediary device may help implement synchronized audio playback across different rooms or zones, improving the home entertainment system by allowing audio from any source (e.g., internal source within a smart device, external device, etc.) to be integrated into a multi-room setup.

The embodiments of the present disclosure will be explained with reference to the accompanying figures. It is to be understood that the figures are diagrammatic and schematic representations of such example embodiments, and are not limiting, nor are they necessarily drawn to scale. In the figures, features with like numbers indicate like structure and function unless described otherwise.

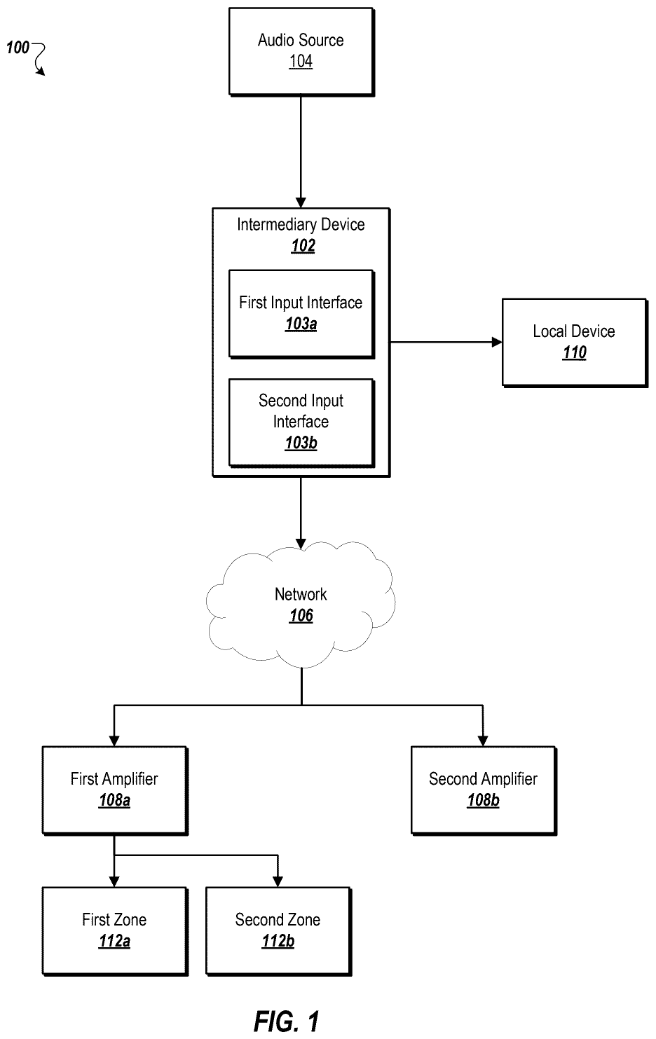

With respect to FIG. 1, FIG. 1 is a block diagram illustrating an environment 100 in which an intermediary device 102 may be implemented. The intermediary device 102 may be configured to receive audio from an audio source and distribute the audio to various devices. For example, the intermediary device 102 may be configured to receive audio signals from an audio source 104. The audio source 104 refers to any device, system, or signal path that generates or provides an audio signal for playback, processing, or distribution to one or more audio output devices. The audio source 104 may include different devices configured to output signals in either analog or digital form. In some embodiments, the intermediary device 102 may be referred to as an audio distribution device.

For example, digital audio sources may include smart televisions generating audio internally from streaming applications, Blu-ray and DVD players, digital gaming consoles, streaming media payers, personal computers or laptops, set-top boxes, etc. Some examples of analog audio sources may include turntables and record players, cassette players and tape decks, compact disc (CD) players, FM/AM radio tuners, legacy VCRs or camcorders, etc.

In some embodiments, the intermediary device 102 may include multiple interfaces configured to connect with the audio source 104. For example, the intermediary device 102 may include a first interface 103a and a second interface 103b (collectively referred to as interfaces 103). While described with respect to two interfaces (e.g., the first interface 103a and the second interface 103b), the intermediary device 102 may include any suitable number of interfaces. In some embodiments, at least one of the interfaces 103 may be configured to receive digital audio inputs. For example, the first interface 103a may be configured to receive or connect with a physical transmission medium designed to carry digital signals. For example, the first interface 103a may be configured to receive a HDMI cable designed to carry HDMI signals between the audio source 104 and the intermediary device 102. The HDMI interface may include extensions such as ARC and eARC. The ARC permits a display device, such as a smart television, to transmit audio upstream to an external audio device. In the present disclosure, an upstream device may refer to a device that transmits data or signals toward a receiving or a central device. A downstream device may refer to a device that receives data or signals from an upstream device within a communication or a signal chain. A downstream device may be responsible for outputting, reproducing, or otherwise processing the received signals. The eARC provides greater bandwidth and improved functionality compared to ARC. eARC support high-bitrate and object-based audio formats such as Dolby TrueHD, DTS-HD Master Audio, Dolby Atomos, etc., such that lossless and immersive audio can be transmitted. In some embodiments, the first interface 103a may include other types of digital interfaces. In another example, the first interface 103a may be any other suitable digital interface such as an optical interface.

In some embodiments, the second interface 103b may include an interface configured to receive analog inputs from the audio source 104. Such analog input interfaces may include, but are not limited to, RCA (Radio Corporation of America) connectors, 3.5 mm auxiliary jacks, 6.35 mm audio jacks, etc. In instances the second interface 103b is an RCA analog input interface, the second interface 103b may be implemented with multiple terminals, for example, a red connector corresponding to a right audio channel and a white connector corresponding to a left audio channel, thereby receiving stereo input.

In some embodiments, the intermediary device 102 may include a processing module operatively coupled to the interfaces 103. The processing module may be configured to process the audio signals obtained via the interfaces 103 to generate audio data to be transmitted. In some embodiments, the processing module may include analog-to-digital conversion (ADC) circuitry. The ADC circuitry may digitize the incoming analog waveform, converting it into a digital audio signal suitable for processing, distribution, and/or transmission across digital interfaces, such as HDMI, TCP/IP (Transmission Control Protocol/Internet Protocol), or wireless protocols.

In some embodiments, the intermediary device 102 may be configured to communicate with one or more amplifiers via a network 106. The network may be established using either wired (e.g., ethernet) or wireless (e.g., Wi-Fi) connections. For example, the intermediary device 102 may be configured to communicate with a first amplifier 108a and a second amplifier 108b (collectively referred to as amplifiers 108) over the network 106. The intermediary device 102 may extract or receive audio signals from various sources (e.g., the audio source 104) and prepare the signals for transmission to the one or more amplifiers 108.

In some embodiments, the amplifiers 118 may represent or be associated with respective zones or locations. For example, the first amplifier 108a may be located in a first zone representing a first room of a building or a house, and the second amplifier 108b may be located in a second zone representing a second room of a building or a house. In some embodiments, the first amplifier 108a and the second amplifier 108b may be located in the same room. For example, the room may be divided into more granular zones. In some embodiments, the size and/or the number of the zones may be determined based on the usage and/or needs of the user. In some embodiments, each amplifier (e.g., the first amplifier 108a and/or the second amplifier 108b) may be associated with multiple zones and/or rooms. For example, the first amplifier 108a may be operatively coupled to a first speaker and a second speaker, in which the first speaker and the second speaker are in different zones. Each amplifier may be connected to any suitable number of zones and/or output devices associated with the zones. For example, the first amplifier 108a may be associated with a first zone 112a and a second zone 112b. The first zone 112a and the second zone 112b may each be associated with one or more audio sources to generate audio output. While illustrated with two amplifiers, the intermediary device may be configured to communicate with any suitable number of amplifiers, and each amplifier may be associated with any suitable number of zones.

In some embodiments, the intermediary device 102 may be configured to utilize wireless networking protocols such as Wi-Fi, Bluetooth, or proprietary low latency audio protocols, among others to transmit audio data packets to the amplifiers 108 located in different rooms or zones within a home entertainment system. In some examples, the intermediary device 102 and the amplifiers 108 may be connected via a TCP/IP network, either through wired Ethernet or wireless IP-based connections. TCP/IP enables the reliable delivery of digital audio streams with packet sequencing, error correction, and retransmission support, thereby providing consistent playback quality across multiple amplifiers 108.

Each amplifier (e.g., the first amplifier 108a and the second amplifier 108b), upon receiving the transmitted audio stream, may further process, amplify, and output the audio to one or more connected audio output devices such as loudspeakers, soundbars, subwoofers, etc. By leveraging TCP/IP networking, the intermediary device 102 may provide synchronized audio distribution across the amplifiers 108 and zones, supporting multi-room or whole-home playback without requiring extensive physical cabling.

In some embodiments, the intermediary device 102 may be configured to manage the distribution of audio signals to the amplifiers 108 while maintaining synchronization across multiple zones. For example, the intermediary device 102 may implement timing control and buffering mechanisms that account for variations in network latency and packet delivery times over the network 106. Additionally, the intermediary device 102 may perform real-time processing to adjust for differences in amplifier processing speeds, network congestion, or clock drift, further enhancing synchronization. The intermediary device 102 may further prioritize low-latency transmission paths and/or implement dynamic error correction to maintain audio fidelity without introducing noticeable delays.

Additionally or alternatively, the intermediary device 102 may be configured to connect directly to local audio devices, such as a local device 110. The local device 110 may include different devices such as a soundbar, a powered speaker, an amplifier, etc. The local device 110 may be a downstream device.

In some embodiments, the intermediary device 102 may be connected to the local device 110 using standard interfaces such as HDMI (with or without ARC or eARC) and RCA analog connectors. The intermediary device 102 may receive audio signals from the audio source 104 and prepare the signals for transmission. In instances the intermediary device 102 and the local device 110 are connected via digital connections, such as HDMI, the intermediary device 102 may transmit uncompressed or compressed audio streams, preserving multi-channel formats and high-fidelity audio, while supporting bidirectional functionality in the case of ARC or eARC.

In instances the intermediary device 102 and the local device 110 are connected via analog connections such as RCA, the intermediary device may convert digital signals to analog form through DAC or pass through analog signals received from legacy or analog sources. In some embodiments, the intermediary device 102 may include additional interfaces configured for communicating with the local device 110. For example, the intermediary device 102 may include a third interface and a fourth interface. The third interface may be a HDMI interface or other digital interfaces configured to communicate digital signals, and the fourth interface may be an RCA interface or other analog interfaces configured to communicate analog signals.

In these and other embodiments, the intermediary device 102, with support for both wired (e.g., HDMI, RCA, Ethernet, etc.) and wireless (e.g., Wi-Fi, Bluetooth, etc.) communication protocols, may be easily integrated into existing network infrastructures, such as home entertainment systems. The intermediary device 102 may help transmit audio signals across the environment 100, regardless of the network setup.

In some embodiments, the intermediary device 102 may include a pass-through interface configured to transmit an original audio signal directly to a downstream device while simultaneously or substantially parallelly extracting and processing the audio signal. For example, the intermediary device 102 may pass through the original audio signal from the audio source 104 directly to the local device 110 while processing the audio signal to be transmitted to the amplifiers 108 wirelessly.

In some embodiments, the intermediary device 102 may be adaptable. For example, the intermediary device 102 may be a standalone unit configured to connect with various devices. In another example, the intermediary device 102 may be embedded into the audio source 104. For example, the intermediary device 102 may be embedded into a television. Such different implementations may provide flexibility to incorporate the functions of the intermediary device 102 into different settings and products.

In some embodiments, the intermediary device 102 may be scalable. For example, the environment 100 implementing the intermediary device 102 may range from simple home theater setups to complex multi-room audio systems. For example, the intermediary device 102 may include a modular hardware and software design that allows additional processing units, storage modules, or input/output interfaces (e.g., HDMI, RCA, Bluetooth, etc.) to be added for different environments. In another example, the intermediary device 102 may communicate with multiple amplifiers and output devices over TCP/IP, Wi-Fi, or Bluetooth, allowing additional zones or amplifiers to be added to the environment 100 without physical rewiring.

In some embodiments, the intermediary device 102 may be configured communicate with a user via a user interface. The user interface may include a mobile application, a web page, and/or other platforms in which the user may interact with the intermediary device 102. The user may be permitted to select an audio source, configured audio routing, and adjust audio processing parameters. For example, the user may define particular audio source to get the audio signals from and the set of output locations (e.g., the amplifiers 108 and/or the local device 110) to transmit the audio data. As another example, the intermediary device may be connected to multiple upstream and/or downstream devices. The user may specify a mapping between the upstream devices and the downstream devices.

Modifications, additions, or omissions may be made to the environment 100 without departing from the scope of the present disclosure. For example, in some embodiments, the environment 100 may include any number of other components that may not be explicitly illustrated or described.

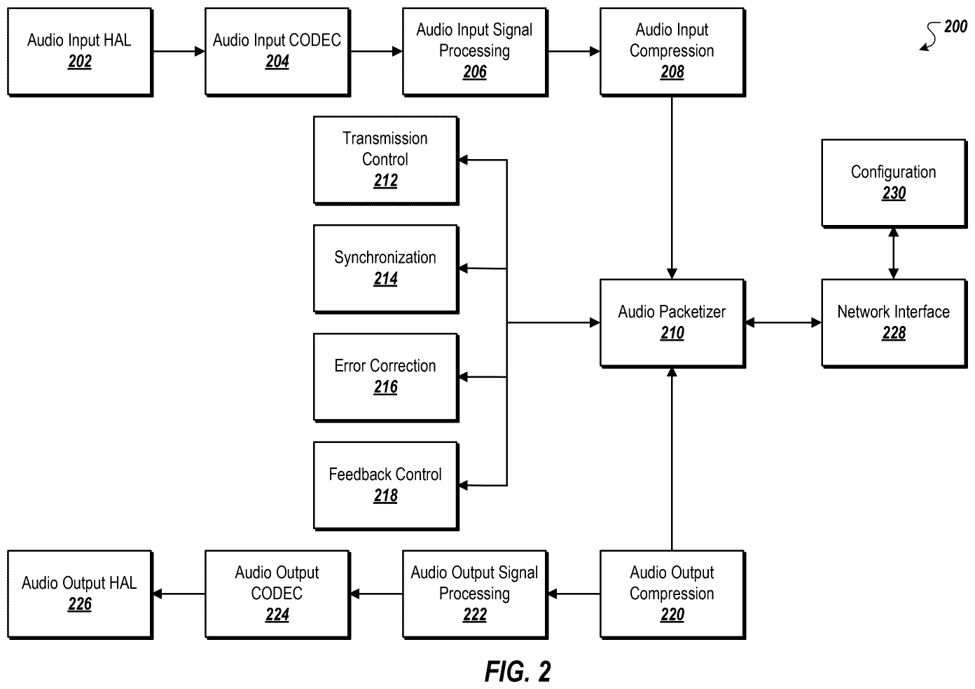

FIG. 2 is a block diagram illustrating the software architecture 200 for capturing, processing, and transmitting audio data, in accordance with one or more embodiments of the present disclosure. In some embodiments, the software architecture 200 may represent the architecture of the intermediary device 102 of FIG. 1. For example, FIG. 2 may illustrate how the intermediary device 102 processes audio signals to be distributed to devices such as the local device 110 and/or the amplifiers 108 of FIG. 1.

In some embodiments, the software architecture 200 may include a set of modules configured to process the audio signals. For example, the architecture 200 may include audio input HAL 202, audio input CODEC 204, audio input signal processing 206, audio input compression 208, audio packetizer 210, transmission control 212, synchronization 214, error correction 216, feedback control 218, audio output compression 220, audio output signal processing 222, audio output CODEC 224, audio output HAL 226, network interface 228, and configuration 230.

The audio input HAL 202 may be configured to receive audio signals or audio streams from various hardware sources such as the audio source 104 of FIG. 1. The audio input CODEC 204 is responsible for decompressing and converting the incoming audio data into a standard digital format that is appropriate for further processing. The output from the audio input CODEC 204 is fed into the audio input signal processing 206, in which the audio data undergoes processing, including volume control, noise filtering, frequency attenuation, and amplification adjustments.

In some embodiments, the audio input compression 208 may be configured to organize the audio data into a buffer and to apply various compression techniques, such as companding (e.g., A-law, μ-law) or other forms of lossless or lossy compression. In some embodiments, the compressed or buffered audio data is then passed to the audio packetizer 210. The audio packetizer 210 may be configured to prepare the audio data for transmission over the network (e.g., the network 106 of FIG. 1), handling tasks such as packet formation and routing. Additionally, the audio packetizer 210 may interface with the transmission control 212, synchronization 214, error correction 216, and/or feedback control 218 to enhance the quality of transmitted audio data with minimal delay and error.

For example, the transmission control 212 manages the flow of data packets, maintaining real-time transmission with minimal latency. The synchronization 214 may be configured to help the audio packets remain in sync with any associated video streams or other audio sources, reducing issues such as lip-sync errors in multi-room setups. The error correction 216 may be configured to apply techniques to detect and correct any errors that might occur during the transmission, enhancing the reliability of the audio stream. The feedback control 218 may be configured to monitor network conditions and to adjust transmission parameters, such as bitrate and compression levels, to maintain optimal audio quality. In some embodiments, the transmission control 212, synchronization 214, error correction 216, and the feedback control 218 may be configured perform respective operations as needed.

In some embodiments, the audio output compression 220 may be configured to receive audio packets and to decompress the audio data. The audio output signal processing 222 may be configured to perform one or more post-processing such as volume adjustment and filtering. The audio output CODEC 224 may be configured to convert the processed digital audio to analog or other output formats suitable for the output devices such as the local device 110 or the amplifiers 108 of FIG. 1. In some embodiments, the audio output HAL may be configured to handle the interface between the software and the output hardware, such as a soundbar or other audio playback devices.

In some embodiments, the network interface 228 may be configured to perform network-related tasks, such as connecting to Wi-Fi, Bluetooth, and/or other wireless protocols, to help the audio data to be transmitted and received efficiently. The configuration 230 may provide a user interface (e.g., via REST API, web page, etc.). The user interface may permit the user to interact with the system (e.g., the intermediary device 102 of FIG. 1) to configure various aspects of the system, such as network settings, sound protocols, audio routing, volume levels, filtering options, etc.

Modifications, additions, or omissions may be made to the architecture 200 without departing from the scope of the present disclosure. For example, in some embodiments, the architecture 200 may include any number of other components that may not be explicitly illustrated or described.

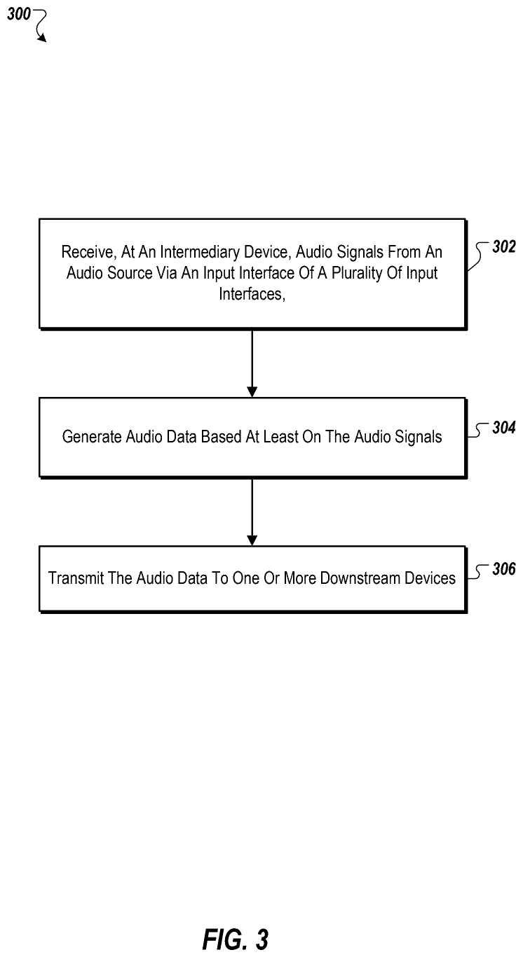

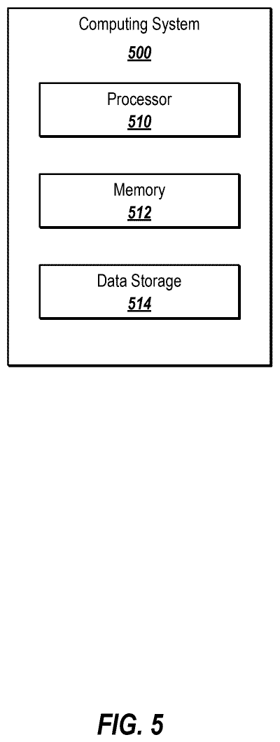

FIG. 3 illustrates a flow chart of an example method 300 for distributing audio inputs, arranged in accordance with at least one embodiment of the present disclosure. One or more operations of the method 300 may be implemented by any suitable system such as the intermediary device 102 of FIG. 1 and/or the computing system 500 of FIG. 5. Although illustrated as discrete steps, various steps of the method 300 may be divided into additional steps, combined into fewer steps, or eliminated, depending on the desired implementation. Additionally, the order of performance of the different steps may vary depending on the desired implementation.

In some embodiments, the method 300 may begin at block 302. At block 302, audio signals may be received at an intermediary device (e.g., the intermediary device 102 of FIG. 1) from an audio source via an input interface of a set of input interfaces. In some embodiments, the set of input interfaces may include different types of local interfaces such as at least one digital input interface and at least one analog input interface. For example, the set of input interfaces may include a High-Definition Multimedia Interface (HDMI) input interface (e.g., a digital input interface) and/or a Radio Corporation of America (RCA) input interface. In some embodiments, the plurality of input interfaces may include a wireless input interface. For example, the intermediary device may include a wireless communication module configured to receive the audio signals wirelessly. For example, the wireless communication module may receive the audio signals via a network using a wireless communication protocol such as Wi-Fi, Bluetooth, etc.

In some embodiments, the intermediary device may be embedded as part of the audio source. For example, in instances where the audio source is a TV, the intermediary device may be built in as an internal part of the TV. In other embodiments, the intermediary device may be a standalone device. The standalone device may be integrated into an existing entertainment systems having different types of devices. For example, the intermediary device is configured to receive both the digital audio signals and the analog audio signals such that the intermediary system may be implemented with different types of devices.

In some embodiments, the audio signals may be analog audio signals. In these and other embodiments, the analog audio signals may be converted to digital audio signals. For example, the intermediary device may include ADC circuitry configured to convert analog signals to digital signals.

At block 304, the intermediary device may generate audio data based at least on the audio signals. The audio signals are the actual electrical waveform or analog representation that directly corresponds to sound waves. The audio data may be a digital representation of sound, usually in the form of encoded or unencoded data streams. The intermediary device may generate the audio data such that the audio data may be transmitted to different types of devices.

At block 306, the audio data may be transmitted to one or more downstream devices. In some embodiments, the one or more downstream devices may include one or more amplifiers at remote locations. The remote locations may represent different locations and/or zones within an environment, such as a house or a building. The amplifiers may be configured to further process the audio data to be played at playback devices, such as speakers, associated with the amplifiers. In some embodiments, the intermediary device may transmit the audio data to the amplifiers over a wireless network. In some embodiments, the amplifiers may be configured to communicate via the TCP/IP protocols. The TCP/IP protocols define how data is packaged, addressed, transmitted, routed, and/or received over a network. In some embodiments, the TCP/IP traffic may ride on top of the network structure, independent of whether the underlying link is Wi-Fi, Ethernet, Bluetooth, cellular, etc. The TCP/IP may help improve reliability and interoperability.

In some embodiments, the one or more downstream devices may include one or more local devices physically coupled to the intermediary device. For example, the local devices may include soundbars, speakers, and/or other devices that may be located near the audio source. For example, a soundbar may be located near a TV. The audio data may be transmitted to the local devices over physical connections such as HDMI cables, RCA cables, etc.

Modifications, additions, or omissions may be made to the method 300 without departing from the scope of the present disclosure. For example, one skilled in the art will appreciate that, for this and other processes, operations, and methods disclosed herein, the functions and/or operations performed may be implemented in differing order. Furthermore, the outlined functions and operations are only provided as examples, and some of the functions and operations may be optional, combined into fewer functions and operations, or expanded into additional functions and operations without detracting from the essence of the disclosed embodiments.

For example, in some embodiments, the method 300 may include synchronizing transmission of the audio data to the one or more downstream devices for substantially simultaneous playback. For example, the audio data transmitted to a first amplifier and a second amplifier of the one or more amplifiers may be synchronized such that the user experience may be improved.

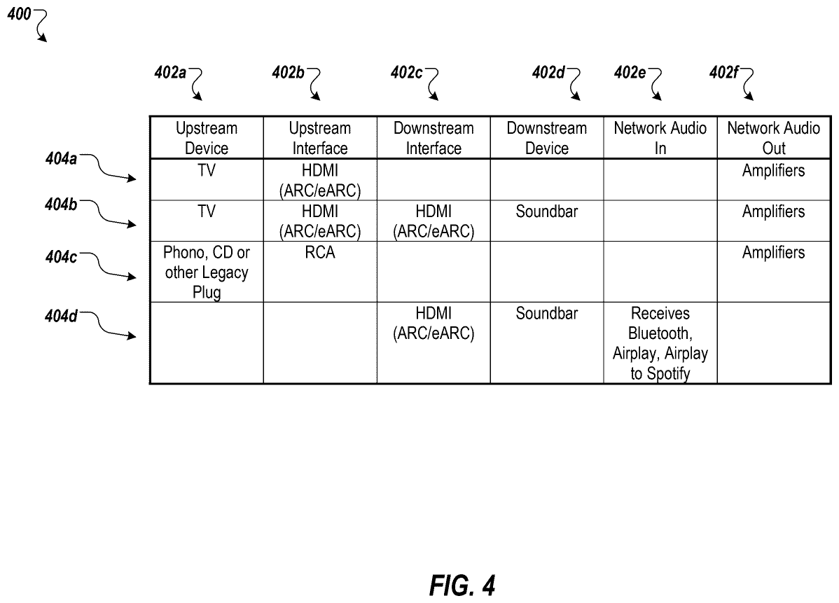

FIG. 4 illustrates a table 400 illustrating examples of data flow between devices, in accordance with one or more embodiments of the present disclosure. In some embodiments, the table 400 may illustrate examples of different devices communicating with an intermediary device (e.g., the intermediary device 102 of FIG. 1) and the interfaces used between the devices and the intermediary device.

In some embodiments, the columns 402 of the table 400 may represent different devices communicating with the intermediary device and the interfaces used. For example, the first column 402a represents upstream devices or devices communicating the audio signals to the intermediary device. The second column 402b represents the upstream interface or the interface used between the upstream device and the intermediary device. The third column 402c represents the downstream interface or the interface used by the intermediary device to communicate the audio data processed based on the audio signal from the upstream device to the downstream devices. The fourth column 402d represents the downstream devices receiving the audio data from the intermediary device for playback and/or further processing. The fifth column 402e represents the audio source the intermediary device receives over the network. The sixth column 402f represents the downstream devices receiving the audio data from the intermediary device over a network (e.g., the network 106 of FIG. 1).

In the first example 404a, the upstream device is a TV (e.g., a smart television) configured to internally generate the audio signals. The audio signals from the TV are communicated to the intermediary device using HDMI interface. The HDMI may be an ARC or an eARC. The intermediary device processes the audio signals and communicates the audio data corresponding to the audio signals to the amplifiers over a network.

In the second example 404b, the upstream device is a TV (e.g., a smart television) configured to internally generate the audio signals. The audio signals from the TV are communicated to the intermediary device using an HDMI interface. The HDMI may be an ARC or an eARC. The intermediary device processes the audio signals and communicates the audio data corresponding to the audio signals to the amplifiers over a network. The intermediary device further communicates the audio data to a soundbar (e.g., a downstream device) via a physical connection. For example, the intermediary device communicates to the soundbar using an HDMI interface. The HDMI may be an ARC or an eARC.

In the third example 404c, the upstream device may be an analog device such as a phono, CD, or other legacy devices. The upstream device communicates analog audio signals to the intermediary device using suitable interfaces such as an RCA interface. The intermediary device processes (e.g., analog-to-digital conversion) the analog audio signals and provides the audio data corresponding to the audio signals to downstream devices. For example, the intermediary device may communicate the audio data to the amplifiers over a network as illustrated in the third example 404c.

In some embodiments, the intermediary device may be configured to receive inputs over a network. For example, the fourth example 404d illustrates the intermediary device receiving audio signals wirelessly or over a wired network. For example, the intermediary device receives audio signals via Bluetooth, Airplay, etc. In some examples, the intermediary device may communicate the received audio signals to the local device, such as a soundbar, via a local interface (e.g., HDMI). In another example, the intermediary device may communicate the audio signals received over a network to the amplifiers. In some embodiments, the intermediary device may provide compatibility with a wide range of audio sources and output devices, and the application of the intermediary device is not limited by the examples provided herein.

FIG. 5 illustrates a block diagram of an example computing system 500 that may be used with respect to a multi-zone audio amplifier, according to at least one embodiment of the present disclosure.

The computing system 500 may include a processor 510, a memory 512, and a data storage 514. The processor 510, the memory 512, and the data storage 514 may be communicatively coupled.

In general, the processor 510 may include any suitable special-purpose or general-purpose computer, computing entity, or processing device including various computer hardware or software modules and may be configured to execute instructions stored on any applicable computer-readable storage media. For example, the processor 510 may include a microprocessor, a microcontroller, a digital signal processor (DSP), an application-specific integrated circuit (ASIC), a Field-Programmable Gate Array (FPGA), or any other digital or analog circuitry configured to interpret and/or to execute program instructions and/or to process data. Although illustrated as a single processor in FIG. 5, the processor 510 may include any number of processors configured to, individually or collectively, perform or direct performance of any number of operations described in the present disclosure. Additionally, one or more of the processors may be present on one or more different electronic devices, such as different servers.

In some embodiments, the processor 510 may be configured to interpret and/or execute program instructions and/or process data stored in the memory 512, the data storage 514, or the memory 512 and the data storage 514. In some embodiments, the processor 510 may fetch program instructions from the data storage 514 and load the program instructions in the memory 512. After the program instructions are loaded into memory 512, the processor 510 may execute the program instructions.

The memory 512 and the data storage 514 may include computer-readable storage media for carrying or having computer-executable instructions or data structures stored thereon. Such computer-readable storage media may include any available media that may be accessed by a general-purpose or special-purpose computer, such as the processor 510. By way of example, and not limitation, such computer-readable storage media may include tangible or non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to store particular program code in the form of computer-executable instructions or data structures and which may be accessed by a general-purpose or special-purpose computer. Combinations of the above may also be included within the scope of computer-readable storage media. Computer-executable instructions may include, for example, instructions and data configured to cause the processor 510 to perform a certain operation or group of operations.

Modifications, additions, or omissions may be made to the computing system 500 without departing from the scope of the present disclosure. For example, in some embodiments, the computing system 500 may include any number of other components that may not be explicitly illustrated or described.

Terms used in the present disclosure and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. Additionally, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B” even if the term “and/or” is used elsewhere.

All examples and conditional language recited in the present disclosure are intended for pedagogical objects to aid the reader in understanding the present disclosure and the concepts contributed by the inventor to furthering the art, and are to be construed as being without limitation to such specifically recited examples and conditions. Although embodiments of the present disclosure have been described in detail, various changes, substitutions, and alterations could be made hereto without departing from the spirit and scope of the present disclosure.

What is claimed is:

1. A method comprising:
receiving, at an intermediary device, audio signals from an audio source via an input interface of a plurality of input interfaces;
generating audio data based at least on the audio signals; and
transmitting the audio data to one or more downstream devices.

2. The method of claim 1, wherein, the audio data is transmitted to the one or more downstream devices using HDMI ARC (High-Definition Multimedia Interface Audio Return Channel) or HDMI eARC (Enhanced Audio Return Channel).

3. The method of claim 1, wherein the plurality of input interfaces includes HDMI ARC or HDMI eARC.

4. The method of claim 1, wherein the plurality of input interfaces includes one or more of a wireless network interface or a wired network interface.

5. The method of claim 1, wherein the one or more downstream devices include one or more amplifiers located at remote locations.

6. The method of claim 5, wherein the audio data is transmitted to the one or more amplifiers over a TCP/IP network, wherein each amplifier of the one or more amplifiers is associated with one or more zones.

7. The method of claim 1, wherein the one or more downstream devices include one or more local devices physically coupled to the intermediary device.

8. The method of claim 7, wherein the audio data is transmitted to the one or more local devices over physical connections.

9. The method of claim 8, wherein the physical connections include includes one or both of a High-Definition Multimedia Interface (HDMI) input interface and a Radio Corporation of America (RCA) input interface.

10. The method of claim 1, wherein the intermediary device receives the audio signals from a television, and transmits the audio data to a soundbar and a multi-zone amplifier, wherein the audio data is transmitted to the multi-zone amplifier over a network.

11. The method of claim 1, wherein the audio signals are analog audio signals.

12. The method of claim 11, further comprising:
converting the analog audio signals to digital audio signals.

13. The method of claim 1, wherein the audio signals are digital audio signals.

14. The method of claim 1, wherein the intermediary device is embedded in the audio source.

15. The method of claim 1, further comprising synchronizing transmission of the audio data to the one or more downstream devices for substantially simultaneous playback.

16. An audio distribution device comprising:
a plurality of input interfaces configured to receive audio signals from an audio source;
a processing module operatively coupled to the plurality of input interfaces and configured to generate audio data based on the audio signals; and
a network communication module configured to transmit the audio data to one or more amplifiers over a network using at least one network communication protocol.

17. The audio distribution device of claim 16, further comprising a local output interface configured to transmit the audio data to a local audio playback device.

18. The audio distribution device of claim 16, wherein the plurality of input interfaces comprises a High-Definition Multimedia Interface (HDMI) input interface and a Radio Corporation of America (RCA) input interface.

19. The audio distribution device of claim 16, wherein the network communication module is configured to support both wired and wireless network protocols, including Ethernet, Wi-Fi, and Bluetooth.

20. The audio distribution device of claim 16, further comprising a user interface configured to allow a user to select the audio source, configure audio routing, and adjust audio processing parameters.

21. The audio distribution device of claim 16, further comprising a pass-through interface configured to transmit an original audio or video signal directly to a downstream device while simultaneously extracting and processing the audio signals.

22. A home entertainment system, comprising:
one or more audio sources configured to output audio signals;
an intermediary device coupled to the one or more audio sources, the intermediary device configured to extract the audio signals from the one or more audio sources to generate audio data; and
one or more downstream devices configured to receive the audio data from the intermediary device.

23. The home entertainment system of claim 22, wherein the one or more audio sources include a television.

24. The home entertainment system of claim 22, wherein the intermediary device includes a plurality of input interfaces including a digital input interface.

25. The home entertainment system of claim 22, wherein the intermediary device is configured to transmit the audio data to the one or more downstream devices using one or both of a wired communication protocol and a wireless network protocol.

26. The home entertainment system of claim 22, wherein the intermediary device is embedded within the one or more audio sources.

27. The home entertainment system of claim 22, wherein the intermediary device is configured as a standalone device integrated into an existing home entertainment system.
